(19) United States
(12) Patent Application Publication
(10) Pub. No.: US 2017/0151851 A1
(43) Pub. Date: Jun. 1, 2017

(54) Automated Suspension Adjuster

(71) Applicant: Steering Solutions IP Holding Corporation, Saginaw, MI (US)

(72) Inventors: Nicholas R. Alpers, Saginaw, MI (US); Matthew R. Burk, Bay City, MI (US); Eric J. Ford, Saginaw, MI (US)

(21) Appl. No.: 15/363,618

(22) Filed: Nov. 29, 2016

Related U.S. Application Data
(60) Provisional application No. 62/260,903, filed on Nov. 30, 2015.

(51) Int. Cl. B60G 17/02; B60G 15/06

(52) U.S. Cl. CPC B60G 17/021; B60G 15/062; B60G 15/063; B60G 2600/20; B60G 2202/312; B60G 2204/1242; B60G 2500/20

(57) ABSTRACT

A shock absorber assembly that includes a piston rod damper is provided. The shock absorber includes a partially hollow screw acting as a telescoping tube for the piston rod damper, a coil spring at least partially surrounding the screw, a nut affixed to the screw and acting as a spring seat for an end of the coil spring and a motor drive for actuating the nut to selectively compress or decompress the spring.

### CROSS-REFERENCE TO RELATED APPLICATION

This patent application claims priority to U.S. Provisional Patent Application Ser. No. 62/260,903, filed Nov. 30, 2015, which is incorporated herein by reference in its entirety.

### FIELD OF THE INVENTION

The embodiments disclosed herein relate to shock absorber assemblies for suspension assemblies and, more particularly, to an automated adjustment assembly for shock absorber assemblies.

### BACKGROUND OF THE INVENTION

A shock absorber assembly generally includes a piston/tube shock mechanism provided with adjustment devices permitting variation of the effective length and thus operating parameters, of a coil spring surrounding the shock mechanism. Adjustment is obtained by the vertical displacement of a member surrounding a body sleeve disposed exteriorly of the shock mechanism and wherein this vertical displacement alters the elevation of one end of the coil spring. A lock nut secures the obtained adjustment. Adjustment of the member and nut may be manipulated with a simple tool cooperating with a specific configuration on the periphery of the member and nut, As such, in order to adjust the effective length, users must exit the vehicle and go to each individual coil and manually turn a retaining nut to adjust the spring downforce pressure of the suspension.

Accordingly, it is desirable to reduce the adjustment time and improve the accuracy of adjustment.

### SUMMARY OF THE INVENTION

In an embodiment of the invention, a shock absorber assembly that includes a piston rod damper is provided. The shock absorber includes a partially hollow screw acting as a telescoping tube for the piston rod damper, a coil spring at least partially surrounding the screw, a nut affixed to the screw and acting as a spring seat for an end of the coil spring and a motor drive for actuating the nut to selectively compress or decompress the spring.

In another embodiment of the invention, a suspension assembly having a shock absorber assembly includes a piston rod damper. Also included is a screw acting as a telescoping tube for the piston rod damper. Further included is a spring at least partially surrounding the screw. Yet further included is a nut affixed to the screw and acting as a spring seat for an end of the coil spring. Also included is a motor drive for actuating the nut to selectively compress or decompress the spring.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a shock absorber assembly of a suspension assembly;

FIG. 2 is a perspective view of the shock absorber assembly connected to a vehicle; and

FIG. 3 illustrates a ball nut and ball screw arrangement of the shock absorber assembly.

### DETAILED DESCRIPTION

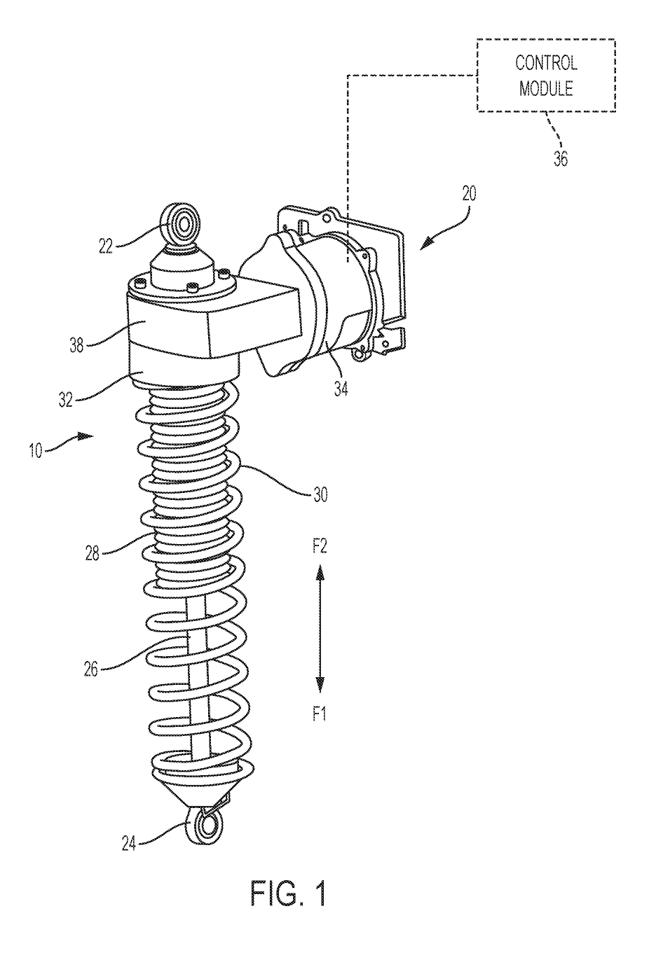

Referring now to the Figures, where the invention will be described with reference to specific embodiments, without limiting same, FIGS. 1-3 show a portion of a suspension assembly 10. In particular, a shock absorber assembly 20 of the suspension assembly 10 is illustrated. As will be appreciated from the disclosure herein, the embodiments of the shock absorber assembly 20 improve current suspension systems in automotive and racing vehicles. However, other types of vehicles may benefit from the embodiments disclosed herein.

FIG. 1 illustrates the shock absorber assembly 20 in accordance with one aspect of the invention. The shock absorber assembly 20 includes an upper mount 22 and a lower mount 24, each attachable to a vehicle (not shown). A damper 26, such as a piston rod or gas shock is disposed between the upper and lower mounts 22, 24 and at least partially disposed or seated within a ball screw 28 at one end, and the lower mount 24 at another end. As shown, a coil spring 30 is disposed about the ball screw 28 and seated at one end on the lower mount 24 and at another end on a ball nut 32. A motor drive 34 is provided and actuated by a control module 36 in response to operator or computer input. The control module 36 may be hardwired, located within the cab of a vehicle, or located remote to the vehicle and activated wirelessly.

In the embodiment shown, a gear box 38 converts motion of the motor drive 34 to actuate the ball nut 32 to apply a force F1 to compress the coil spring 30 or to drive the ball nut 32 in a reverse direction F2 to decompress the coil spring 30. Movement of the ball nut 32 in the F1 and F2 directions causes the suspension assembly 10 to become more or less compliant.

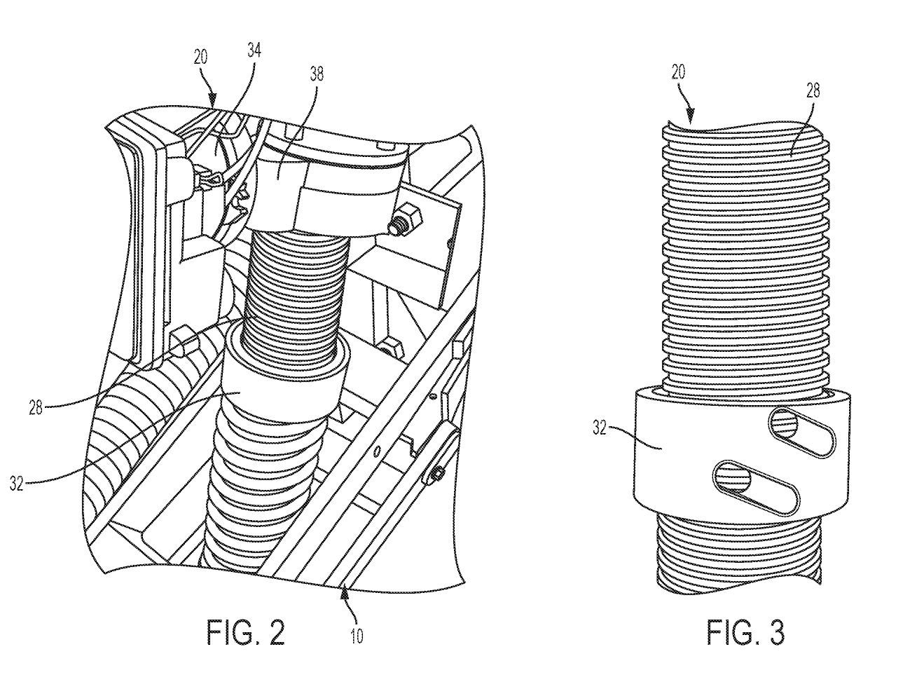

As shown in FIG. 2, an individual suspension assembly is attached to the vehicle chassis at each corner of the vehicle in the vicinity of a road wheel. FIG. 3 illustrates one aspect of the invention showing the ball nut 32 and ball screw 28 arrangement.

The suspension assembly 10 reduces the adjustment time required by a user when adjusting the shock absorber assembly 20. In addition, operator error is reduced or eliminated in applying adjustment when applying a down force pressure to stiffen the suspension or relieving the down force pressure to make the suspension more compliant. Specifically, the automated capability of the shock absorber assembly 20 eliminates user time and reduces the opportunity for error between suspension points. With this system, automated spring adjust forces are applied through a signal sent from a control module.

In an embodiment of the invention, an operator adjusts each of the individual suspension points simultaneously, with accuracy, and with a large reduction of time. This adjustment may occur from the cab of the vehicle or could be done wirelessly and remotely by a racing crew.

In another embodiment of the invention, each individual assembly can either be adjusted together or be adjusted independently; or any combination in between. In one embodiment, this can account for racing suspension tuning where it may be desirable to have different down pressure from one suspension point to another suspension point.

The automated suspension adjuster is accomplished by eliminating the manual adjust retaining nut seen in prior art embodiments, such as that disclosed in U.S. Pat. No. 5,044,614, which is incorporated by reference in its entirety. Furthermore, systems that are not presently adjustable can now be adjusted by adding the suspension assembly shown in FIGS. 1-3.

In an embodiment of the invention, all systems will be able to adapt to gas shocks and can utilize the existing spring. It will be appreciated that the invention may be used on multiple point of a vehicle and chassis. Load is applied to the existing spring utilizing an electric motor and gear box paired to a ball screw/ball nut combination for compactness and efficiency. This allows the spring pressure to be adjusted while the vehicle is stationary or in motion.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A shock absorber assembly comprising;
a piston rod damper;
a partially hollow screw acting as a telescoping tube for the piston rod damper;
a coil spring at least partially surrounding the screw;
a nut affixed to the screw and acting as a spring seat for an end of the coil spring; and
a motor drive for actuating the nut to selectively compress or decompress the spring.

2. The shock absorber assembly of claim 1, wherein the hollow screw is a ball screw and the nut is a ball nut.

3. The shock absorber assembly of claim 1, including a gear box disposed between the motor drive and the nut.

4. The shock absorber assembly of claim 1, including a control module electrically connected to the motor drive for actuating the motor drive to a predetermined spring setting.

5. The shock absorber assembly of claim 4, wherein the control module is in hardwired connection with the motor drive.

6. The shock absorber assembly of claim 4, wherein the control module is in wireless connection with the motor drive.

7. The shock absorber assembly of claim 4, wherein the control module includes a user interface disposed in the cab of a vehicle.

8. The shock absorber assembly of claim 4, wherein the control module includes a user interface accessible on a mobile electronic device.

9. The shock absorber assembly of claim 1, wherein the shock absorber assembly is coupled to a suspension assembly of a vehicle.

10. The shock absorber assembly of claim 9, wherein the shock absorber assembly is coupled to a suspension assembly of a racing vehicle.

11. The shock absorber assembly of claim 9, wherein the shock absorber assembly is one of a plurality of shock absorber assemblies of the suspension assembly, each of the plurality of shock absorber assemblies simultaneously adjustable with a control module.

12. The shock absorber assembly of claim 9, wherein the shock absorber assembly is one of a plurality of shock absorber assemblies of the suspension assembly, each of the plurality of shock absorber assemblies independently adjustable with a control module.

13. A suspension assembly having a shock absorber assembly comprising;
a piston rod damper;
a screw acting as a telescoping tube for the piston rod damper;
a spring at least partially surrounding the screw;
a nut affixed to the screw and acting as a spring seat for an end of the coil spring; and
a motor drive for actuating the nut to selectively compress or decompress the spring.

14. The shock absorber assembly of claim 13, wherein the screw is a ball screw and the nut is a ball nut.

15. The shock absorber assembly of claim 14, including a gear box disposed between the motor drive and the nut.

16. The shock absorber assembly of claim 15, including a control module electrically connected to the motor drive for actuating the motor drive to drive the ball nut a predetermined distance corresponding to a selected spring setting.

17. The shock absorber assembly of claim 16, wherein the shock absorber assembly is one of a plurality of shock absorber assemblies of a suspension assembly, each of the plurality of shock absorber assemblies simultaneously adjustable with the control module.

18. The shock absorber assembly of claim 16, wherein the shock absorber assembly is one of a plurality of shock absorber assemblies of a suspension assembly, each of the plurality of shock absorber assemblies independently adjustable with the control module.

19. The shock absorber assembly of claim 16, wherein the control module includes a user interface disposed in a cab of a vehicle.

20. The shock absorber assembly of claim 16, wherein the control module includes a user interface accessible on a mobile electronic device.
